(19) United States
(12) Patent Application Publication
(10) Pub. No.: US 2017/0288424 A1
(43) Pub. Date: Oct. 5, 2017

(54) CHARGE-DISCHARGE CONTROL CIRCUIT

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(72) Inventors: Shunichi SAWANO, Yokkaichi, Mie (JP); Katsuya IKUTA, Yokkaichi, Mie (JP)

(73) Assignees: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(21) Appl. No.: 15/514,336

(22) PCT Filed: Sep. 15, 2015
(86) PCT No.: PCT/JP2015/076077

§ 371 Date: Mar. 24, 2017

(30) Foreign Application Priority Data
Sep. 29, 2014 (JP) 2014-198293

(51) Int. Cl. H02J 7/00

(52) U.S. Cl. CPC H02J 7/0019; H02J 7/0021; H02J 7/345

(57) ABSTRACT

The present invention aims to efficiently use all of a plurality of capacitors connected in series, and control a voltage held by a capacitor unit according to environmental temperature. A switch element inserted into a charging path leading to the capacitor unit, and a switch control part controlling the opening and closing of the switch element, are provided. The switch control part includes: a first voltage divider circuit that includes a pair of resistor elements, and that produces and outputs a voltage that is a fraction of the voltage held by the capacitor unit; and a comparison result output circuit that controls the opening and closing of the switch element based on the result of comparing a potential output from the first voltage divider circuit and a predetermined potential. The pair of resistor elements are different from each other in terms of temperature dependency of resistance values thereof.

### CROSS-REFERENCE TO RELATED APPLICATIONS

This application is the U.S. national stage of PCT/JP2015/076077 filed Sep. 15, 2015, which claims priority of Japanese Patent Application No. JP 2014-198293 filed Sep. 29, 2014.

### FIELD OF THE INVENTION

The present invention relates to a charge-discharge control circuit, and is applicable to technology for charging and discharging a sub battery circuit that uses a capacitor, for example.

### BACKGROUND

In recent years, hybrid vehicles and electrical vehicles have been developed in order to improve fuel efficiency. Gasoline vehicles are also desired to achieve improved fuel efficiency by, for example, stopping the idling of the engine.

However, once the engine has been shut down in order to stop idling for example, the battery is not charged by the alternator. Therefore, when the engine is restarted, a phenomenon called “cranking”, in which the battery voltage sharply decreases, occurs.

If cranking occurs and the battery voltage sharply decreases, there is the risk of the body ECU (electrical control unit) of the automobile erroneously performing low-voltage reset.

In order to avoid such a situation, there is well-known technology for addressing cranking by providing a sub battery such as a large-capacity capacitor, separately from the battery.

This sub battery for addressing cranking is also employed as, for example, an auxiliary power supply for unlocking a door when the vehicle crashes and the battery is lost.

Due to degradation over time, the capacitance of the capacitor used as the sub battery decreases, and the internal resistance of the same increases. The progression of this degradation over time is widely known as Arrhenius behavior, and the environmental temperature follows the “10° C. rise and double reaction rate” rule.

The progression of degradation of a capacitor also affects charging voltage. If the environmental temperature is constant, the capacitor is less likely to degrade the lower the charging voltage is.

For a sub battery circuit using such a capacitor, an example of technology for preventing the capacitor from degrading and supplying the required energy in response to changes in the environmental temperature is discussed in Patent Document 1 shown below.

Specifically, Patent Document 1 shown below discloses

(i) charging a capacitor unit serving as an auxiliary power supply from a battery serving as a main power supply;

(ii) stopping the charging of some of a plurality of capacitors that constitute the capacitor unit; and

(iii) a fact that whether or not to stop charging and whether or not to restart the charging in (ii) mentioned above is determined based on the temperature in the vicinity of the capacitor unit.

Due to control (i) to (iii) shown above, the charging voltage applied to the capacitor unit is reduced when the environmental temperature is high in order to prevent the capacitors from degrading while securing sufficient energy to be supplied by the capacitor unit.

Also, Patent Document 2 introduces technology in which a bypass circuit is provided for each of a plurality of batteries that constitute an assembled battery. When the charging potential of a given battery exceeds a predetermined charging potential, the bypass circuit corresponding to the battery is brought into a conductive state so that non-uniformity among the batteries in terms of charging voltage is alleviated.

However, according to the technology introduced in Patent Document 1, as shown in (ii), step-by-step control is performed to determine whether or not some of the capacitors are to be charged. Consequently, it is uneasy to perform the control based on the temperature as shown in (iii). In other words, it is difficult to set a temperature threshold value for determining whether or not to stop/restart charging. Moreover, since there are capacitors that do not contribute to power supply when the environmental temperature is high, the capacitors provided in the capacitor unit are not efficiently used, and there is a disadvantage in terms of cost.

Also, according to the technology introduced in Patent Document 2, the voltage at which charging is performed can only be uniquely determined, and it is not suggested that the charging voltage varies depending on the temperature.

Considering the above problems, the present invention aims to provide technology for efficiently using all of the plurality of capacitors that are connected in series, and controlling the voltage held by the capacitor unit according to the environmental temperature.

### SUMMARY OF INVENTION

A first aspect is a charge-discharge control circuit for charging and discharging a capacitor unit that includes a plurality of capacitors that are connected to each other in series. The charge-discharge control circuit includes: a discharging control circuit that controls discharging of each of the capacitors separately; a charging control circuit that controls charging of the capacitor unit with respect to all of the capacitors at once. The charging control circuit includes: a switch element that is inserted into a charging path leading to the capacitor unit; and a switch control part that controls the opening and closing of the switch element. The switch control part includes: a first voltage divider circuit that includes a pair of resistor elements, and that produces and outputs a voltage that is a fraction of a voltage held by the capacitor unit; and a comparison result output circuit that controls the opening and closing of the switch element based on the result of comparing a potential output from the first voltage divider circuit and a predetermined potential. The pair of resistor elements are different from each other in terms of temperature dependency of resistance values thereof.

A second aspect is the charge-discharge control circuit according to the first aspect, wherein the discharging control circuit includes: a plurality of discharging parts that respectively compare voltages held by the plurality of capacitors with a same threshold value, and respectively control discharging of the plurality of capacitors; and a second voltage divider circuit that produces a value that is obtained by dividing the voltage held by the capacitor unit by the number of capacitors connected in series in the capacitor unit, and outputs the value as the threshold value.

A third aspect is the charge-discharge control circuit according to the first aspect or the second aspect, wherein the predetermine potential is a positive value, a resistance value of a first resistor element connected to a higher potential side of the capacitor unit, out of the pair of resistor elements, has a first temperature coefficient, a resistance value of a second resistor element connected to a lower potential side of the capacitor unit, out of the pair of resistor elements, has a second temperature coefficient that is higher than the first temperature coefficient, and the comparison result output circuit brings the switch element into a non-conductive state upon the potential output from the first voltage divider circuit exceeding the predetermined potential.

A fourth aspect is the charge-discharge control circuit according to the third aspect, wherein the first temperature coefficient is a negative temperature coefficient, and the second temperature coefficient is a positive temperature coefficient.

A fifth aspect is the charge-discharge control circuit according to the third aspect or the fourth aspect, wherein the first voltage divider circuit further includes: a third resistor element that is connected in parallel with the first resistor element, and has a third temperature coefficient that is higher than the first temperature coefficient.

According to the first aspect, the voltage across the capacitor unit is converted to a voltage with consideration of the temperature, and is provided to the comparison result output circuit. As a result, charging of all of the capacitors is performed with consideration of the temperature, and thus the voltage held by the capacitor unit is controlled according to the environmental temperature. In addition, all of the capacitors that are connected in series are used.

According to the second aspect, the charging voltages of the plurality of capacitors included in the capacitor unit and connected in series are equalized, and degradation due to non-uniformity among the charging voltages is prevented.

According to the third aspect, the voltage across the capacitor unit is converted to a higher fractional voltage for a higher environmental temperature. Therefore, as the environmental temperature increases, the voltage across the capacitor unit at which the switch element can be brought into a non-conductive state decreases, and the voltages held by the capacitors can be set to be lower.

According to the fourth aspect, the first resistor element and the second resistor element according to the third aspect can be easily selected.

According to the fifth aspect, it is easier to finely adjust the conversion from the voltages across the capacitors to the potential at the connection point.

### BRIEF DESCRIPTION OF THE DRAWINGS

FIG. 1 is a diagram showing a configuration according to an embodiment.

FIG. 2 is a circuit diagram showing configurations of a part of a discharging control circuit and a charging control circuit.

FIG. 3 is a circuit diagram showing a configuration of a discharge control part.

FIG. 4 is a graph showing time dependency of a voltage held by a capacitor unit and voltages held by capacitors.

FIG. 5 is a graph schematically showing a relationship between a voltage held by the capacitor unit and the environmental temperature.

FIG. 6 is a circuit diagram showing a configuration of a modification of a first voltage divider circuit.

FIG. 7 is a circuit diagram showing a configuration of another modification of the first voltage divider circuit.

### DETAILED DESCRIPTION OF THE PREFERRED EMBODIMENTS

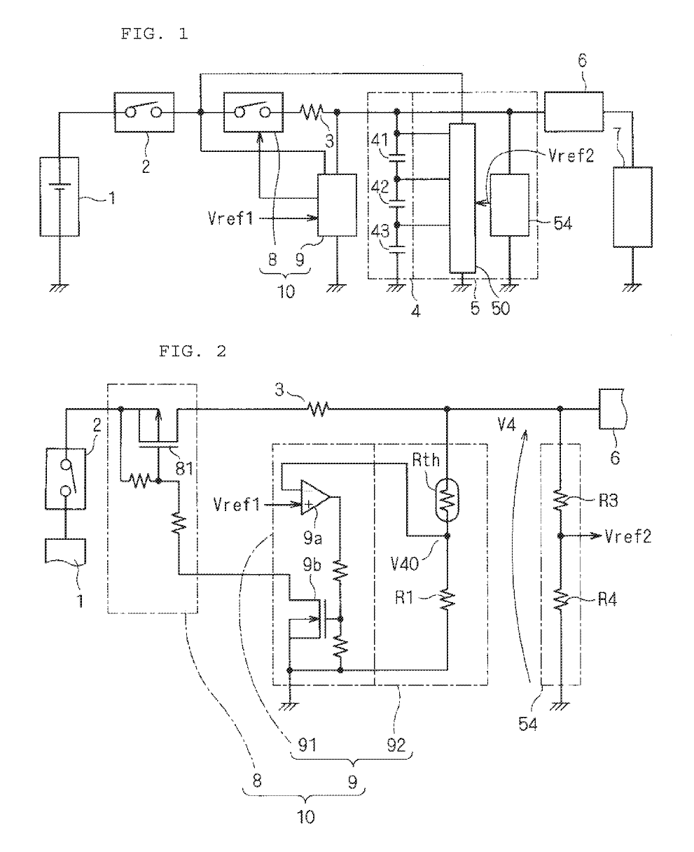

The following describes a charge-discharge control circuit according to an embodiment. FIG. 1 is a circuit diagram showing a capacitor unit 4, a charge-discharge control circuit that controls the charging and discharging of the capacitor unit 4, and elements connected to the capacitor unit 4 and the charge-discharge control circuit.

A battery 1 is, for example, an on-board battery, and is charged by an alternator or the like (not shown). A relay 2 is, for example, an ignition relay, and is brought into a conductive state when the engine is ignited. One end of an electrical current limiting resistor 3 is connected to the positive electrode of the battery 1 via the relay 2, and the other end is connected to the higher potential side of the capacitor unit 4.

The capacitor unit 4 is connected between the other end of the electrical current limiting resistor 3 and the negative electrode of the battery 1. In other words, the battery 1, the relay 2, and the electrical current limiting resistor 3 are connected in parallel with the capacitor unit 4. Note that the negative electrode of the battery 1 in FIG. 1 is grounded.

The capacitor unit 4 includes capacitors 41, 42, and 43 that are connected to each other in series. The capacitor 41 is provided on the higher potential side of the capacitor 42, and the capacitor 42 is provided on the higher potential side of the capacitor 43. The higher potential side terminal of the capacitor 41 is connected to said other end of the electrical current limiting resistor 3, and the lower potential side terminal of the capacitor 43 is connected to the negative electrode of the battery 1.

Although the capacitor unit 4 includes three capacitors in this example, the capacitor unit 4 only needs to include a plurality of capacitors, and the number of capacitors may be suitably determined.

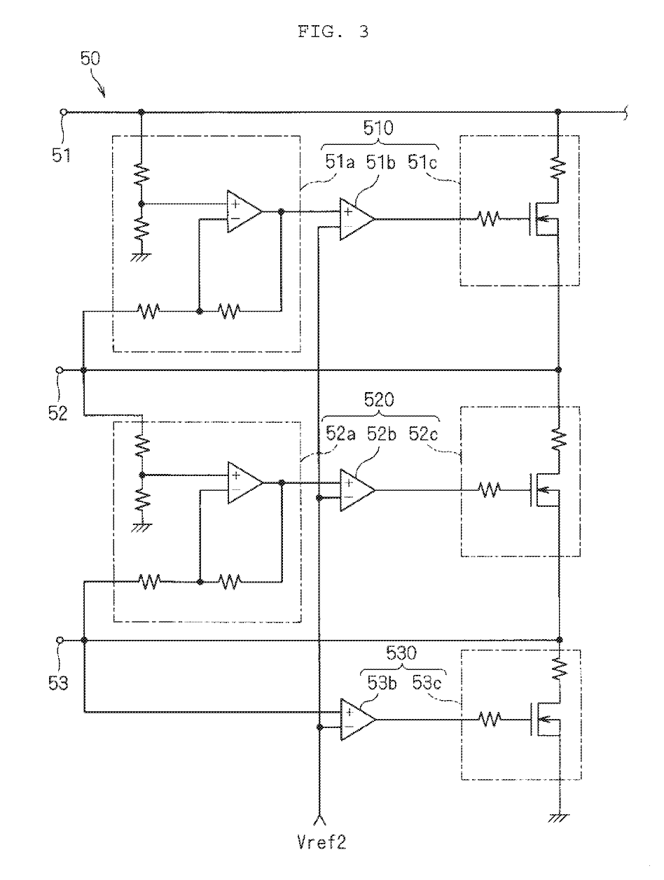

The charge-discharge control circuit includes a discharging control circuit 5 and a charging control circuit 10. The discharging control circuit 5 controls the discharging of each of the capacitors 41, 42 and 43 separately. The charging control circuit 10 controls the capacitors 41, 42, and 43 all at once to charge the capacitor unit 4. The charging control circuit 10 includes a switch element 8 and a switch control part 9. FIG. 2 is a circuit diagram showing the configurations of a part of the discharging control circuit 5 and the charging control circuit 10.

A converter 6 is, for example, a step-up DC/DC converter. For example, a voltage held by the capacitor unit 4 is input to the converter 6, and the converter 6 steps up this voltage and supplies the voltage to a load 7. The load 7 is, for example, a motor for unlocking a door.

The switch element 8 is inserted into a charging path leading to the capacitor unit 4 (in this example, the path on which the battery 1, the relay 2, and the electrical current limiting resistor 3 are connected in series). The switch element 8 includes, for example, a PMOS transistor 81 (see FIG. 2).

The switch control part 9 controls the opening and closing of the switch element 8. As shown in FIG. 2, the switch control part 9 includes a first voltage divider circuit 92 and a comparison result output circuit 91. The first voltage divider circuit 92 has the function of dividing a voltage V4 that is held by the capacitor unit 4 and outputting a potential V40, and includes a pair of resistor elements Rth and R1. The pair of resistor elements Rth and R1 are different from each other in terms of temperature dependency of their respective resistance values.

The comparison result output circuit 91 controls the opening and closing of the switch element 8 based on the result of comparing the potential V40 and a predetermined potential Vref1. The comparison result output circuit 91 includes, for example, a comparator 9a and an NMOS transistor 9b.

The following describes a situation in which the relay 2 is ON. If the switch element 8 is ON, the battery 1 supplies a charging current to the capacitor unit 4. If the switch element 8 is turned OFF, the supply of charging current is blocked.

If the potential V40 is higher than the predetermined potential Vref1, the output from the comparator 9a is at the lower potential, and the NMOS transistor 9b is turned OFF. Upon the NMOS transistor 9b being turned OFF, the PMOS transistor 81 is turned OFF due to the gate potential thereof raising. Therefore, the switch element 8 is brought into a non-conductive state.

If the potential V40 is lower than or equal to the predetermined potential Vref1, the output from the comparator 9a is at the higher potential, the NMOS transistor 9b is turned ON, and the gate potential of the PMOS transistor 81 is lowered. Consequently, the PMOS transistor 81 is turned ON, and the switch element 8 is brought into a conductive state.

The potential V40 is a fraction, produced by the first voltage divider circuit 92, of a voltage V4 that is held by the capacitor unit 4, and this potential V40 is supplied to the comparison result output circuit 91. As a result, charging of all of the capacitors 41, 42, and 43 is performed with consideration of the temperature, and thus the voltage held by the capacitor unit 4 is controlled according to the environmental temperature. In addition, all of the capacitors 41, 42, and 43 that are connected in series are used.

FIG. 3 is a circuit diagram showing the configuration of a discharge control part 50. The discharge control part 50 is provided with a plurality of discharging parts 510, 520, and 530 that are connected in series, and input terminals 51, 52, and 53.

The discharging parts 510, 520, and 530 are provided so as to respectively correspond to the capacitor 41, 42, and 43. In the discharge control part 50, the number of discharging parts 510, 520, and 530 is the same as the number of capacitors 41, 42, and 43 included in the capacitor unit 4.

In this example, the input terminal 51 is connected to the higher potential side of the capacitor 41, the input terminal 52 is connected to the lower potential side of the capacitor 41 and the higher potential side of the capacitor 42, and the input terminal 53 is connected to the lower potential side of the capacitor 42 and the higher potential side of the capacitor 43.

As a matter of course, the number of discharging parts included in the discharge control part 50 may be greater than the number of capacitors included in the capacitor unit 4. However, a discharging part that does not correspond to a capacitor (in other words, a redundant discharging part) is not relevant to the operation of the present embodiment.

The discharging part 510 includes a differential amplifier circuit 51a, a comparator 51b, and a switch element 51c. The differential amplifier circuit 51a can be configured by using, for example, an operational amplifier and a resistor element. The differential amplifier circuit 51a outputs the voltage between the input terminals 51 and 52 (i.e. the voltage held by the capacitor 41) with reference to the lower potential side of the capacitor unit 4 (the ground in this example).

The comparator 51b compares the output from the differential amplifier circuit 51a with a threshold value Vref2, and controls the opening and closing of the switch element 51c based on the comparison result. The switch element 51c is connected between the input terminals 51 and 52.

Specifically, if the output from the differential amplifier circuit 51a is higher than the threshold value Vref2, the switch element 51c is brought into a conductive state, and thus the capacitor 41 discharges electricity. If the output from the differential amplifier circuit 51a is lower than or equal to the threshold value Vref2, the switch element 51c is brought into a non-conductive state, and thus the capacitor 41 is prevented from discharging electricity. Usually, the input resistance of the operational amplifier included in the differential amplifier circuit 51a is significantly high, and therefore the amount of discharge from the capacitor 41 is small when the switch element 51c is not conductive.

The discharging part 520 includes a differential amplifier circuit 52a, a comparator 52b, and a switch element 52c. The differential amplifier circuit 52a outputs the voltage between the input terminals 52 and 53 (i.e. the voltage held by the capacitor 42) with reference to the lower potential side of the capacitor unit 4. The differential amplifier circuit 52a can be configured in the same manner as the differential amplifier circuit 51a.

The comparator 52b compares the output from the differential amplifier circuit 52a with the threshold value Vref2, and controls the opening and closing of the switch element 52c based on the comparison result. The switch element 52c is connected between the input terminals 52 and 53. Therefore, if the output from the differential amplifier circuit 52a is higher than the threshold value Vref2, the capacitor 42 discharges electricity, and if the output from the differential amplifier circuit 52a is lower than or equal to the threshold value Vref2, the capacitor 42 is prevented from discharging electricity.

The discharging part 530 includes a comparator 53b and a switch element 53c in the same manner as the discharging parts 510 and 520. However, a differential amplifier circuit is not required. This is because the potential of the capacitor 43 is determined with reference to the lower potential side of the capacitor unit 4.

The comparator 53b compares the potential of the input terminal 53 with the threshold value Vref2, and the opening and closing of the switch element 53c is controlled based on the comparison result.

The switch element 53c is connected between the input terminal 53 and the lower potential side of the capacitor unit 4. Therefore, if the potential of the input terminal 53 is higher than the threshold value Vref2, the capacitor 43 discharges electricity, and if the potential of the input terminal 53 is lower than or equal to the threshold value Vref2, the capacitor 43 is prevented from discharging electricity.

Charging and discharging a capacitor (at least one capacitor) included in a capacitor unit by opening and closing a switch element connected to the capacitor in parallel is well known. Therefore, a further detailed description of the operation of the discharging parts 510, 520, and 530 is omitted.

In this way, in the discharging control circuit 5, the discharging parts 510, 520, and 530 respectively compare the voltages held by the capacitors 41, 42, and 43 with the same threshold value Vref2, and respectively control the discharging of the capacitors 41, 42, and 43. Thus, the charging voltages of the capacitors 41, 42, and 43 included in the capacitor unit 4 and connected in series are equalized, and degradation due to non-uniformity among the charging voltages is prevented.

Note that, as can be seen from the above description, whether or not the capacitors 41, 42, and 43 are to discharge electricity depends on the result of comparison between the voltage held by each of the capacitors 41, 42, and 43 and the threshold value Vref2. The capacitors 41, 42, and 43 in the capacitor unit 4 are connected in series, and therefore the threshold value Vref2 needs to be 1/3 of the voltage V4 held by the capacitor unit 4.

For this reason, the discharging control circuit 5 also includes a second voltage divider circuit 54. The second voltage divider circuit 54 produces a value V4×(1/N) by dividing the voltage V4 by the number N (N=3 in this example) of the capacitors 41, 42, and 43 connected in series in the capacitor unit 4, and outputs the value V4×(1/N) as the threshold value Vref2.

Specifically, as shown in FIG. 2 for example, the second voltage divider circuit 54 includes a pair of resistor elements R3 and R4 that are connected in series between the higher potential side and the lower potential side of the capacitor unit 4. The resistor elements R3 and R4 are respectively located on the higher potential side and the lower potential side of the capacitor unit 4. The resistance value of the resistor element R3 is set to be (N−1) times the resistance value of the resistor element R4. As a result, the threshold value Vref2=V4×(1/N) is obtained from the connection point of the resistor elements R3 and R4.

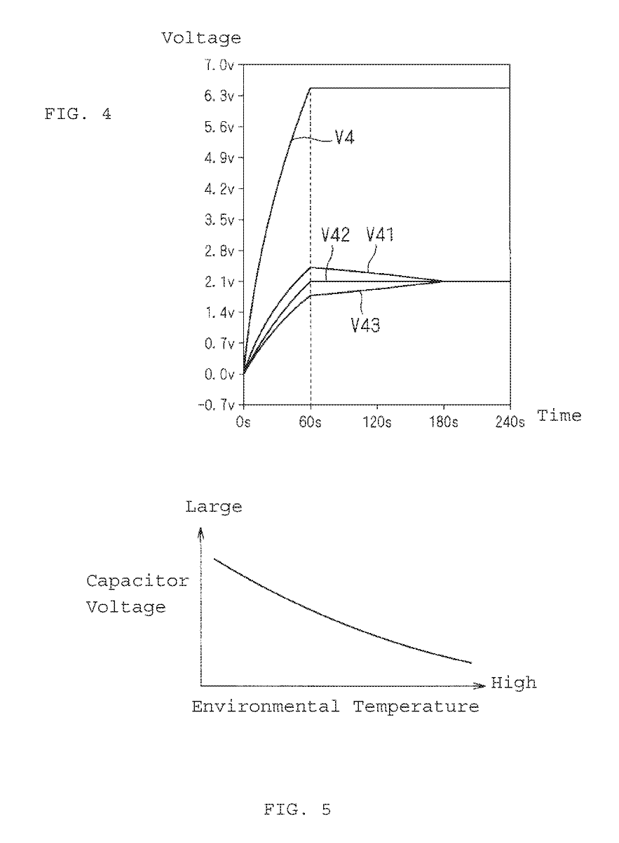

FIG. 4 is a graph showing the time dependency of the voltage V4 held by the capacitor unit 4 and voltages V41, V42, and V43 respectively held by the capacitors 41, 42, and 43. In the capacitor unit 4, the capacitors 41, 42, and 43 are connected in series. Therefore, a relationship V4=V41+V42+V43 is satisfied.

A state in which the capacitors 41, 42, and 43 have been completely discharged and V4=V41=V42=V43=0 is satisfied is set as the initial state. Also, in order to facilitate understanding, capacitances C41, C42, and C43 of the capacitors 41, 42, and 43 are set so as to satisfy C41<C42<C43.

Time 0s is the point in time at which the relay 2 is brought into a conductive state. Before time 0s, V4=0 is satisfied and the switch element 8 is conductive. From time 0s, the capacitor unit 4 is charged by the battery 1.

As described above, C41<C42<C43 is satisfied. Therefore, the V41>V42>V43 is satisfied while the capacitor unit 4 is being charged.

Due to the capacitor unit 4 being charged, the voltage V4 keeps increasing. The threshold value Vref2 also keeps increasing while the voltage V4 keeps increasing, and therefore the voltages V41, V42, and V43 keep increasing as well.

When the voltage V4 reaches approximately 6.3 V at time 60s, the switch element 8 is brought into a non-conductive state due to the function of the switch control part 9. Thereafter, upon the voltage V4 decreasing due to a slight amount of discharge from the capacitors 41, 42, and 43, the switch element 8 is brought into a conductive state again, and the charging of the capacitor unit 4 is restarted. Consequently, the voltage V4 is thereafter maintained at approximately 6.3 V while oscillating. Note that such an oscillation is ignored in FIG. 4 (the same applies to the voltages V41, V42, and V43).

In this way, the voltage V4 is almost constant at approximately 6.3V, and the threshold value Vref2 is constant at approximately 6.3/3=2.1 V. Thus, the voltage V42 that was approximately 2.1 V at time 60s is maintained at the value.

On the other hand, the voltage V41 that was higher than 2.1 V at time 60s decreases toward 2.1 V (the switch element 51c discharges the capacitor 41).

Also, the voltage V43 that was lower than 2.1 V at time 60s increases toward 2.1 V. This is because the capacitor 41 discharges electricity, and the electrical charge accumulated in the capacitor 41 charges the capacitor 43.

In this way, in the vicinity of time 180s, all of the voltages V41, V42, and V43 are approximately equal to 2.1 V, and these voltages will be maintained thereafter.

Regarding the above-described configuration, a case in which the predetermined potential Vref1 is set to be a positive value with reference to the lower potential side of the capacitor unit 4 (the ground in this example) will be more specifically described. Out of the resistor elements Rth and R1, a second temperature coefficient for the resistance value of the resistor element R1 connected to the lower potential side of the capacitor unit 4 is higher than a first temperature coefficient for the resistance value of the resistor element Rth connected to the higher potential side of the capacitor unit 4.

For example, the resistor element R1 is a normal resistor element and has a positive temperature coefficient. For example, a thermistor having a negative temperature coefficient is employed as the resistor element Rth.

It is well known that a resistance value Rtth, at an environmental temperature Tth, of a thermistor having a negative temperature coefficient is expressed by the following equation using a resistance value RO at a reference temperature TO and a thermistor coefficient B.

Rtth=R0·exp [B·(1/Tth−1/T0)]

Note that the symbol exp[ ] denotes an exponential function with respect to the value in the brackets.

Therefore, the voltage V4 held by the capacitor unit 4 is converted to a higher potential V40 for a higher environmental temperature. Therefore, as the environmental temperature increases, the voltage across the capacitor unit at which the switch element 8 can be brought into a non-conductive state decreases, and the voltages held by the capacitors 41, 42, and 43 can be set to be lower. It has already been mentioned above that the voltages held by the capacitors can be set to be lower as the environmental temperature increases.

FIG. 5 is a graph schematically showing the relationship between the voltage V4 obtained by the above-described operation and the environmental temperature. This graph shows that the capacitor voltage decreases as the environmental temperature increases.

As a matter of course, the first temperature coefficient and the second temperature coefficient are not necessarily different in terms of their polarities. It is only required that the switch element 8 can be brought into a non-conductive state when the second temperature coefficient is higher than the first temperature coefficient and the potential V40 is higher than the predetermined potential Vref1.

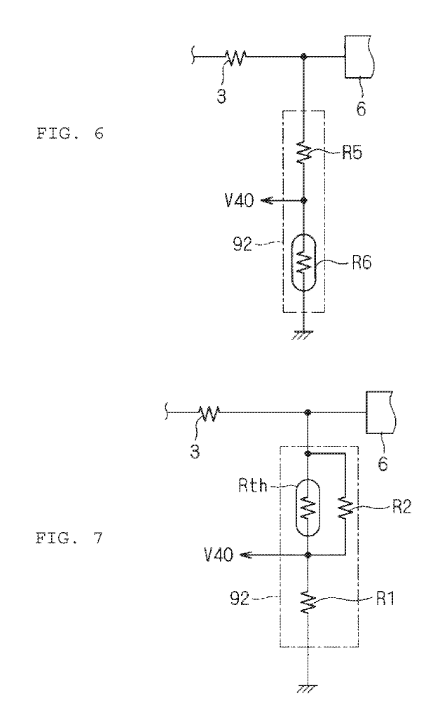

FIG. 6 is a circuit diagram showing a modification of the first voltage divider circuit 92. The first voltage divider circuit 92 according to this modification has a configuration in which the resistor elements Rth and R1 of the first voltage divider circuit 92 shown in FIG. 2 have been replaced with resistor elements R5 and R6, respectively.

As with the case of the resistor elements Rth and R1, the second temperature coefficient for the resistance value of the resistor element R6 is higher than the first temperature coefficient for the resistance value of the resistor element R5. However, note that the resistor element R1 is a normal resistor element and has a positive temperature coefficient. For example, a thermistor having a positive temperature coefficient is employed as the resistor element R6.

Even in such a case, the voltage V4 is converted to a higher voltage for a higher environmental temperature. Therefore, the capacitor unit 4 is less likely to be charged the higher the environmental temperature is, and it is possible to suppress the voltage V4, and accordingly suppress the voltages V41, V42, and V43.

Alternatively, it is possible to employ a configuration in which the second temperature coefficient is lower than the first temperature coefficient. If this is the case, the comparison result output circuit 91 may be re-designed as appropriate so as to have another configuration in which, for example, the inverting input terminal and the non-inverting input terminal of the comparator 9a have been interchanged.

FIG. 7 is a circuit diagram showing another modification of the first voltage divider circuit 92. The first voltage divider circuit 92 according to this modification is characterized by a resistor element R2 being connected in parallel with the resistor element Rth of the first voltage divider circuit 92 shown in FIG. 2. A third temperature coefficient for the resistance value of the resistor element R2 is higher than the first temperature coefficient for the resistance value of the resistor element Rth.

With this configuration, it is easier to finely adjust the conversion from the voltage V4 to the potential V40 according to the environmental temperature.

Note that the above-described configurations can be combined as appropriate insofar as there is no contradiction with each other.

Although the present invention has been described in detail above, the above description is merely an example in terms of all aspects, and the present invention is not limited to the description. It can be understood that it is possible to conceive of numerous modifications that are not presented as examples, without departing from the scope of the present invention.

1. A charge-discharge control circuit for charging and discharging a capacitor unit that includes a plurality of capacitors that are connected to each other in series, the charge-discharge control circuit comprising:
a discharging control circuit that controls discharging of each of the capacitors separately; and
a charging control circuit that controls charging of the capacitor unit with respect to all of the capacitors at once,
wherein the charging control circuit includes:
a switch element that is inserted into a charging path leading to the capacitor unit; and
a switch control part that controls opening and closing of the switch element,
the switch control part includes:
a first voltage divider circuit that includes a pair of resistor elements, and produces and outputs a voltage that is a fraction of a voltage held by the capacitor unit: and
a comparison result output circuit that controls opening and closing of the switch element based on a result of comparing a potential output from the first voltage divider circuit and a predetermined potential, and
the pair of resistor elements are different from each other in terms of temperature dependency of resistance values thereof.

2. The charge-discharge control circuit according to claim 1,
wherein the discharging control circuit includes:
a plurality of discharging parts that respectively compare voltages held by the plurality of capacitors with a same threshold value, and respectively control discharging of the plurality of capacitors; and
a second voltage divider circuit that produces a value that is obtained by dividing the voltage held by the capacitor unit by the number of capacitors connected in series in the capacitor unit, and outputs the value as the threshold value.

3. The charge-discharge control circuit according to claim 1,
wherein the predetermined potential is a positive value,
a resistance value of a first resistor element connected to a higher potential side of the capacitor unit, out of the pair of resistor elements, has a first temperature coefficient,
a resistance value of a second resistor element connected to a lower potential side of the capacitor unit, out of the pair of resistor elements, has a second temperature coefficient that is higher than the first temperature coefficient, and
the comparison result output circuit brings the switch element into a non-conductive state upon the potential output from the first voltage divider circuit exceeding the predetermined potential.

4. The charge-discharge control circuit according to claim 3,
wherein the first temperature coefficient is a negative temperature coefficient, and the second temperature coefficient is a positive temperature coefficient.

5. The charge-discharge control circuit according to claim 3,
wherein the first voltage divider circuit further includes:
a third resistor element that is connected in parallel with the first resistor element, and has a third temperature coefficient that is higher than the first temperature coefficient.

6. The charge-discharge control circuit according to claim 2,
wherein the predetermined potential is a positive value,
a resistance value of a first resistor element connected to a higher potential side of the capacitor unit, out of the pair of resistor elements, has a first temperature coefficient,
a resistance value of a second resistor element connected to a lower potential side of the capacitor unit, out of the pair of resistor elements, has a second temperature coefficient that is higher than the first temperature coefficient, and
the comparison result output circuit brings the switch element into a non-conductive state upon the potential output from the first voltage divider circuit exceeding the predetermined potential.

7. The charge-discharge control circuit according to claim 4,
wherein the first voltage divider circuit further includes:
a third resistor element that is connected in parallel with the first resistor element, and has a third temperature coefficient that is higher than the first temperature coefficient.
